(19) United States
(12) Patent Application Publication
(10) Pub. No.: US 2007/0223523 A1
(43) Pub. Date: Sep. 27, 2007

(54) METHOD AND APPARATUS FOR CUSTOMIZATION OF NETWORK SERVICES AND APPLICATIONS

(75) Inventors: Marie Jose Montpetit, Jamaica Plain, MA (US); Liang Q. Liu, Clifton (GB); Zeng-Jun Justin Xiang, Vernon Hills, IL (US); David R. Flanagan, Framingham, MA (US); Rahul B. Kher, Tewksbury, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/688,898

(22) Filed: Mar. 21, 2007

Related U.S. Application Data
(60) Provisional application No. 60/786,156, filed on Mar. 27, 2006.

(51) Int. Cl. H04J 3/22

(52) U.S. Cl. 370/465; 370/252

(57) ABSTRACT

A communication system is provided that ensures that a rich variety and complexity of network offerings may be experienced by users without overloading terminals and clients by offering user-centric network services. When a user device first registers with a network, the user device notifies the network of its client capabilities, such as video, VoIP, presence, and so on. Based on the client capabilities and further based on any user preferences, the network then announces, that is, offers to the user, a list of available services for the user to choose from. Network services and applications then may be downloaded and used only when the services and applications are needed or desired by users, thereby allowing a thin middleware layer and network customization.

### CROSS-REFERENCE TO RELATED APPLICATION

This application claims priority from provisional application Ser. No. 60/786,156, entitled “METHOD AND APPARATUS FOR CUSTOMIZATION OF NETWORK SERVICES AND APPLICATIONS,” filed Mar. 27, 2006, which is commonly owned and incorporated herein by reference in its entirety.

### FIELD OF THE INVENTION

The present invention relates generally to next generation communication systems and, in particular, to a dynamic customization of services and applications provided to a user device in a next generation communication system.

### BACKGROUND OF THE INVENTION

With the emergence of third and fourth generation communication systems, richer sets of applications and services are expected to be deployed in the systems and to become available for use by user devices. One result of such developments is that an ever greater number and variety of services and applications are likely to become available to an ever larger number of, and a wider variety of, user devices. Due to the variety of services and the limited storage capacity of user devices, the user devices are likely to subscribe to and/or support only a portion of the available services and applications. Thus the diversity of user devices and the large number of available services and applications may result in a large number of potential combinations of services and applications available to, and supported by and/or subscribed by, user devices operating in the network.

Furthermore, some of these services and applications may be dynamic, short-lived, and location dependent, with the result that it may be inefficient for a user device to permanently maintain software that may be uniquely associated with any particular service or application. Furthermore, with the variety of pricing plans used to market cellular services to consumers and corresponding capabilities of the user devices, the capabilities of the user devices are likely to vary greatly, providing service providers with abundant opportunities to market new services and applications to such a user device based on the capabilities of the user device or a desire to market upgrades to a user of the user device.

Therefore, the need exists for a method and apparatus that provides for an offering of network services and applications to a user device that are customized based on the combination of services and applications supported by, subscribed to, and/or preferred by the user device and further supported by the network serving the user device and/or based on a desire to market an upgrade to a user of the user device.

### BRIEF DESCRIPTION OF THE DRAWINGS

FIG. 1 is a block diagram of a wireless communication system in accordance an embodiment of the present invention.

FIG. 2 is a block diagram of a user device in accordance with various embodiments of the present invention.

FIG. 3 is a block diagram of a user device in accordance with various embodiments of the present invention.

FIG. 4 is a logic flow diagram illustrating a providing of customized network services and/or applications by the communication system of FIG. 1 to the user device of FIG. 1 in accordance with various embodiments of the present invention.

FIG. 5 is signal flow diagram illustrating providing of customized network services and/or applications by the communication system of FIG. 1 to the user device of FIG. 1 in accordance with various embodiments of the present invention.

### DETAILED DESCRIPTION OF THE INVENTION

To address the need for a method and apparatus that provides for an offering of network services and applications to a user device that are customized based on the combination of services and applications supported by, subscribed to, and/or preferred by the user device and further supported by a network serving the user device and/or based on a desire to market an upgrade to a user of the user device, a communication system is provided that ensures that a rich variety and complexity of network offerings may be experienced by users without overloading terminals and clients by offering user-centric network services. When a user device first registers with a network, the user device notifies the network of its client capabilities, such as video, VoIP, presence, and so on. Based on the client capabilities and further based on any user preferences, the network then announces, that is, offers to the user, a list of available services for the user to choose from. Network services and applications then may be downloaded and used only when the services and applications are needed or desired by users, thereby allowing a thin middleware layer and network customization.

Generally, an embodiment of the present invention encompasses a method for providing network service and application customization. The method includes determining a capability of a user device, determining one or more network services and applications supported by a network, determining the requirements of the one or more network services and applications, and announcing one or more of a network service and an application to the user device based on the determined capability of the user device and the requirements of the one or more network services and applications supported by the network.

Another embodiment of the present invention encompasses a method for providing network service and application customization. The method includes determining one or more network services and applications that are one or more of supported by and preferred by a user device, determining one or more network services and applications supported by a network, and announcing one or more of a network service and an application to the user device based on the one or more network services and applications that are one or more of supported by and preferred by a user device and the one or more network services and applications supported by a network.

Yet another embodiment of the present invention encompasses a network server that provides a customized offering of one or more of a network service and an application to a user device. The network server is configured to determine a capability of the user device, determine one or more network services and applications supported by a network, determine the requirements of the one or more network services and applications, and announce one or more of a network service and an application to the user device based on the capabilities of the user device and the requirements of the one or more network services and applications supported by the network.

Still another embodiment of the present invention encompasses a network server that provides a customized offering of one or more of a network service and an application to a user device. The network server is configured to determine one or more network services and applications that are one or more of supported by and preferred by the user device, determine one or more network services and applications supported by a network, and announce one or more of a network service and an application to the user device based on the one or more network services and applications that are one or more of supported by and preferred by a user device and the one or more network services and applications supported by a network.

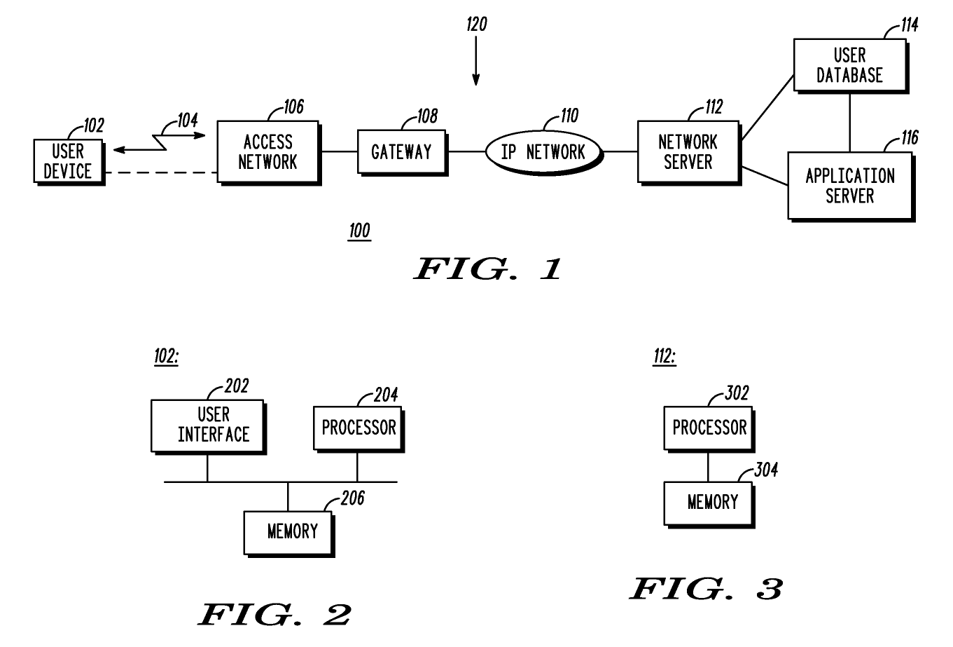

Turning now to the drawings, the present invention may be more fully described with reference to FIGS. 1-5. FIG. 1 is a block diagram of a wireless communication system 100 in accordance with an embodiment of the present invention. Communication system 100 comprises an access network 106 coupled to a media gateway 108 and, via the media gateway, to an Internet Protocol (IP) network 110. In various embodiments of the present invention, access network 106 may comprise a wireless access network having a BTS coupled to a BSC, an Access Point (AP), or a Node B coupled to a Radio Network Controller (RNC), and media gateway 108 may comprise any type packet data gateway such as but not limited to one or more of a Packet Data Serving Node (PDSN), a Media Gateway (MGW), an IMS Gateway, a Mobile Switching Center (MSC) with packet data functionality, and a Packet Data Interworking Function (PDIF).

Communication system 100 further includes a user communication device 102, for example but not limited to a cellular telephone, a radiotelephone, or a Personal Digital Assistant (PDA), personal computer (PC), or laptop computer equipped for wireless voice communications. In various communications systems, user device 102 may also be referred to as a mobile station (MS), a subscriber unit (SU), an access terminal (AT), or a user's equipment (UE). When access network 106 is a wireless access network, access network 106 provides wireless communication services to user devices located in a coverage area of the access network, such as user device 102, via an air interface 104. Air interface 104 includes a forward link that includes a pilot channel, at least one forward link traffic channel, and forward link common and dedicated signaling channels. Air interface 104 further includes a reverse link that includes at least one reverse link traffic channel, reverse link common and dedicated signaling channels, and an access channel. However, in another embodiment of the present invention, access network 106 may not be wireless and user device 102 may communication with access network 106 via a wireline link, such as an Ethernet, a cable, or an optical fiber link.

Communication system 100 further includes a core network that comprises a network server 112 coupled to IP network 110, a user database 114, and at least one application server (AS) 116 that are each coupled to each other via signaling interfaces. Preferably, the core network comprises an IP Multimedia Core Network Subsystem (IMS), network server 112 comprises an IMS Server, and user database 114 is maintained in a Home Subscriber Server (HSS). The IMS Server may comprise one or more of a Proxy-Call Session Control Function (P-CSCF), an Interrogating Call Session Control Function (I-CSCF), and a Serving Call Session Control Function (C-CSCF). However, in other embodiments of the present invention, one or more of the P-CSCF, I-CSCF, and C-CSCF may be implemented in separate elements of communication system 100.

User database 114 maintains subscription-related information, that is, a user profile, for each user, performs authentication and authorization of users, and provides information about a physical location of each user. Each user's profile includes a user device identifier associated with that user, that is, with a user device of the user, and further includes information such as the capabilities of the user device and a listing of network services subscribed to by the user. Thus, when a user seeks to activate a network service or application, the network my determine, by reference to the user's profile stored in user database 114, one or more of whether the user device is capable of supporting such an application or service and whether, if appropriate, the user device is subscribed to and/or as expressed a preference for such an application or service. AS 116 hosts and executes services and applications that may be employed by a user device operating in communication system 100, for example but not limited to caller-ID related services, call waiting, call holding, push-to-talk (PTT), call blocking, lawful interception, announcement services, conference call services, voicemail, text-to-speech, speech-to-text, location based services, short message service (SMS), Multimedia Messaging Services (MMS), presence information, and instant messaging. The at least one memory device 304 of network server 112 may also maintain a list of services and applications that may be employed by a user device operating in communication system 100 and supported by the network server 112.

Together, access network 106, media gateway 108, IP network 110, network server 112, user database 114, and AS 116 may collectively be referred to herein as a communication system network 120 and each of the access network, media gateway, network server, user database and AS comprises a network element. Although single interfaces have been described herein between many of the network elements of communication system 100, each interconnection among elements may comprise multiple interconnections and/or interfaces, such as one or more of a signaling interface, for example, an interface for an exchange of SIP, ISUP, MAP, or Megaco messages, and a bearer interface or path, such a path for an exchange of voice information.

FIG. 2 is a block diagram of user device 102 in accordance with an embodiment of the present invention. User device 102 includes a user interface 202 coupled to a processor 204, such as one or more microprocessors, microcontrollers, digital signal processors (DSPs), combinations thereof or such other devices known to those having ordinary skill in the art. User interface 202 provides a user of the user device with the capability of interacting with the user device, including inputting instructions into the user device. In one embodiment of the present invention, user interface 202 may include a display screen and a keypad that includes multiple keys that may be used by a user of the user device to input instructions into the user device. In another embodiment of the present invention, display screen may comprise a touch screen. User device 102 further includes at least one memory device 206 associated with processor 204, such as random access memory (RAM), dynamic random access memory (DRAM), and/or read only memory (ROM) or equivalents thereof, that maintain data and programs that may be executed by the processor and that allow the user device to perform all functions necessary to operate in communication system 100.

Preferably, user device 102 is a thin client device that is capable of using “thin client” techniques for remote execution of applications while the results are viewed locally. For example, products such as pcAnywhere™ from Symantec Corporation, Unix X-Windows, and Citrix MetaFrame™ provide the capability of using one computing device as the screen and keyboard for another, remotely located computer. These products are often called “thin clients” because the processing and software requirements of the client device are relatively small, typically just enough to act as a remote keyboard, mouse, and display. Also, the thin client may have little locally stored information. The application software runs on a remote computer, usually a server, or the user's desktop computer. Thin client technology and wireless connectivity are useful for such computing because they allow a user to carry lightweight devices with long battery life yet still have the ability to run virtually any application. However, since there are occasions when connections are not available, for example on airplanes, thin clients also typically have some local computing capability.

For example, lightweight devices incorporating operating systems such as Windows CE™ or the Palm Operating System (Palm OS) are capable of running thin client software and controlling the execution of programs on a remote server. This solves the problem of downloading large files and of being unable to view and manipulate certain file types locally. Thus a remote server can provide all of a user's computing needs, including email. The user can operate the lightweight user device as a remote screen and keyboard to control the email software and any application programs necessary for viewing, editing, or manipulating email attachments. The thin client can also selectively download plug-ins from a serving network, such as network 120, and store the plug-ins in the at least one memory device 206 of the user device when needed or desired or when the user device and/or network determine to run an application locally instead of remotely.

FIG. 3 is a block diagram of network server 112 in accordance with an embodiment of the present invention. Network server 112 includes a processor 302, such as one or more microprocessors, microcontrollers, digital signal processors (DSPs), combinations thereof or such other devices known to those having ordinary skill in the art. Network server 112 further includes at least one memory device 304 associated with processor 302, such as random access memory (RAM), dynamic random access memory (DRAM), and/or read only memory (ROM) or equivalents thereof, that store data and programs, such as Session Initiation Protocol (SIP)-related programs, that may be executed by the processor and that allow the network server to perform all functions necessary to operate in communication system 100.

The embodiments of the present invention preferably are implemented within each of user device 102 and network server 112, and more particularly with or in software programs and instructions stored in the at least one memory devices and executed by the processors of the user device and network server. However, one of ordinary skill in the art realizes that the embodiments of the present invention alternatively may be implemented in hardware, for example, integrated circuits (ICs), application specific integrated circuits (ASICs), and the like, such as ASICs implemented in the user device or IMS Server, and all references to ‘means for’ herein may refer to any such implementation of the present invention. Based on the present disclosure, one skilled in the art will be readily capable of producing and implementing such software and/or hardware without undo experimentation.

Preferably, communication system 100 is a Universal Mobile Telecommunication System (UMTS) communication system that operates in accordance with the 3GPP (Third Generation Partnership Project) standards. To ensure compatibility, radio system parameters and call processing procedures are specified by the standards, including call processing steps that are executed by a user device and a RAN serving the user device and between the RAN and associated infrastructure in order to establish a call or execute a handoff. However, those who are of ordinary skill in the art realize that communication system 100 may operate in accordance with any one of a variety of packet data communication systems capable of providing packet data services, such as but not limited to a General Packet Radio Service (GPRS) communication system, a packet switched CDMA (Code Division Multiple Access) communication system, such as a CDMA 2000 1XEV-DO (1X Evolution Data Only), a CDMA 2000 1XEV-DV (1X Evolution Data and Voice) or a packet switched CDMA 1RTT (1X Radio Transmission Technology) communication system, a Wireless Local Area Network (WLAN) communication system as described by the IEEE (Institute of Electrical and Electronics Engineers) 802.xx standards, for example, the 802.11, 802.15, 802.16, or 802.20 standards, or Fourth Generation (4G) communication systems such as an Orthogonal Frequency Division Multiple Access (OFDM) communication system.

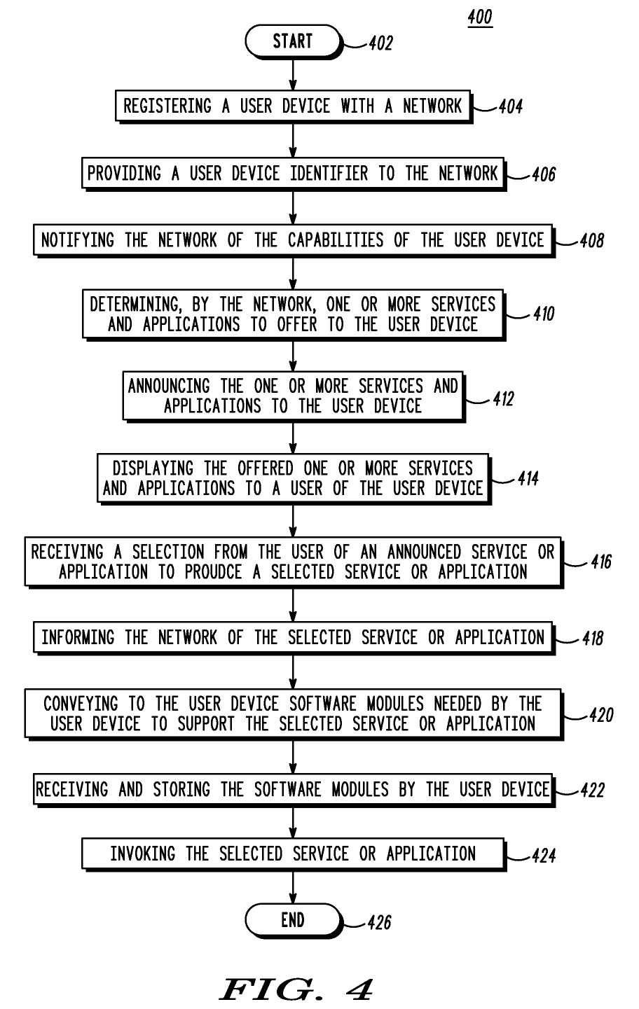

Referring now to FIG. 4, a logic flow diagram 400 is provided that illustrates a providing of customized network services and/or applications by communication system 100 to a user communication device, such as user device 102, in accordance with various embodiments of the present invention. Logic flow diagram 400 begins (402) when a user communication device, such as user device 102, registers (404) with a network servicing the user device, that is, network 120. For example, the user device may register with the network when the user device activates in a coverage area of the network or when the user device roams into a coverage area of the network. As part of the registration process, and as is known in the art, user device 102 identifies (406) itself, for example, by conveying a user device identifier, and notifies (408) network 120, and in particular network server 112, of capabilities of the user device, such as data rates, codecs, transport protocols, and media types supported by the user device, whether the user device can support a video communication session, whether the user device can support a Voice over Internet Protocol (VoIP) call, provides presence information, and so on. However, in another embodiment of the invention wherein the capabilities of user device 102 are already known to network 120, for example, are included in the user profile associated with the user device and maintained by user database 114, user device 102 may or may not notify the network of its capabilities or the notification conveyed by the user device to network server 112 at step 408 may refer the network server to the services and/or applications maintained in the user profile associated with the user device in user database 114.

In response to receiving the registration information from user device 102, the network routes at least a portion of the registration information, including the user device identifier, to network server 112. In response to receiving the at least a portion of the registration information, network server 112 determines (410) one or more network services and applications to offer to user device 102. In one embodiment of the invention, network server 112 may determine which network services and/or applications to offer to user device 102 based on the capabilities of the user device and the requirements of the offered services. That is, network server 112 may determine the capabilities of user device 102 based on the information provided by the user device and/or based on a query of user database 114 for the capabilities of the user device maintained in the user profile associated with the user device. Network server 112 further determines the services and/or applications that are supported by network 120 by retrieving, from the at least one memory device 304 of the server, information concerning services and/or applications maintained by the server and/or by querying the at least one AS 116 for a list of network services and/or applications supported by the at least one AS. Network server 112 further obtains the requirements of such network supported services and/or applications. Network server 112 then may compare the capabilities of the user device to the requirements of the network services and applications supported by network 120 and determines to offer to user device 102 network services and applications that can be supported by the user device.

In another embodiment, network server 112 may further, or instead, determine which network services and/or applications to offer to user device 102 based on network services and applications that the network server determines are subscribed to and/or preferred by the user device. Network server 112 may determine the network services and/or applications subscribed to and/or preferred by the user device based on the information provided by the user device and/or based on a query of user database 114 for the services and/or applications subscribed to and/or preferred by the user device and maintained in the user profile associated with the user device. Network server 112 further determines the services and/or applications that are supported by network 120 as described in detail above, and then network server 112 then may compare the services and/or applications subscribed to and/or preferred by the user device to the services and applications supported by network 120 and determines to offer to user device 102 network services and applications subscribed to and/or preferred by the user device and supported by the network.

In yet another embodiment of the present invention, network server 112 may further, or instead, determine to offer network services and/or applications that may further include, or may instead include, network services and/or applications that are supported by network 120 but that the user device may not be aware of and that the user device may or may not be capable of using. In this manner, an operator of network 120 may give a user of user device 102 an opportunity to subscribe to new services and/or to upgrade user device 102 in order to use such services.

Network server 112 then compiles a listing of network services and/or applications to be offered to user device 102 and announces (412), or offers, that is, conveys, the listed network services and/or applications to user device 102.

In response to receiving the announcement, or offering, of available network services and/or applications, user device 102 displays (414) a corresponding listing of the announced/offered services and/or applications to the user of the user device via user interface 202. The user of user device 102 may then select an announced service or application for download or activation to produce a selected service or application and inputs to the user device, and the user device receives (416) from the user, his or her selection via user interface 202. In response to receiving the selection, user device 102 informs (418) network 120, and in particular to network server 112, of the selected service or application, preferably by conveying to the network 120, a request to download and/or to activate the selected service and/or application. In response to being informed of the service or application selected by the user of user device 102, network server 112 retrieves one or more software modules from AS 116 or from the at least one memory device 304 of the network server that are needed by user device 102 in order to support the selected service and/or application and conveys (420) the retrieved software module or modules to user device 102. In response to receiving the software module or modules, user device 102 stores (422) the received software module or modules in the at least one memory device 206 of the user device. User device 102 may then invoke (424) the selected service or application, and logic flow 400 then ends (426). The invocation of the selected service or application may be automatic or may be based on an instruction manually input by the user of user device 102 into the user device. For example, user device 102 may automatically invoke the selected service or application in response to receiving the module(s) or user device 102 may query the user of the user device, via user interface 202, to invoke the selected service or application and subsequently invoke the selected service or application in response to receiving an instruction from the user to do so.

As noted above, in one embodiment of the present invention the services and/or applications offered to user device 102 may comprise services and/or applications supported by, subscribed to, and/or preferred by user device 102. However, in another embodiment of the present invention, the services and/or applications offered to user device 102 may further, or instead, include a service and/or application new to the user device, that is, a service and/or application not currently subscribed to, or not currently subscribed to and further not supported by, user device 102. In the latter embodiment, when user device 102 receives the listing of offered services and/or applications, the user device may further display, in user interface 202, a query as to whether the user of the user device wishes to subscribe to such a new service or application. The user of user device 102 may then input an instruction into the user device via user interface 202 to subscribe to such a service or application, including, when appropriate, a request to download software upgrades that would make it possible for the user device to support the service or application. In response to receiving such an instruction and/or request, user device 102 conveys a request to network 120, and in particular to network server 112, to subscribe to such a service or application and, when appropriate, to download the software upgrades. Network server 112 processes the request, including arranging for on-line charging of an account associated with the user of the user device and set up with a Billing System (BS) of network 120, for example, a BS of an IMS core network domain when network server 112 is an IMS server, for use of the service or application and, when appropriate, for a download of software that makes it possible for the user device to support the service or application. On-line billing, including on-line billing in the IMS domain, is well known in the art and will not be described in greater detail herein. Network server 112 then conveys the appropriate software module(s) and/or upgrades to user device 102 and the user device may then invoke the new service or application.

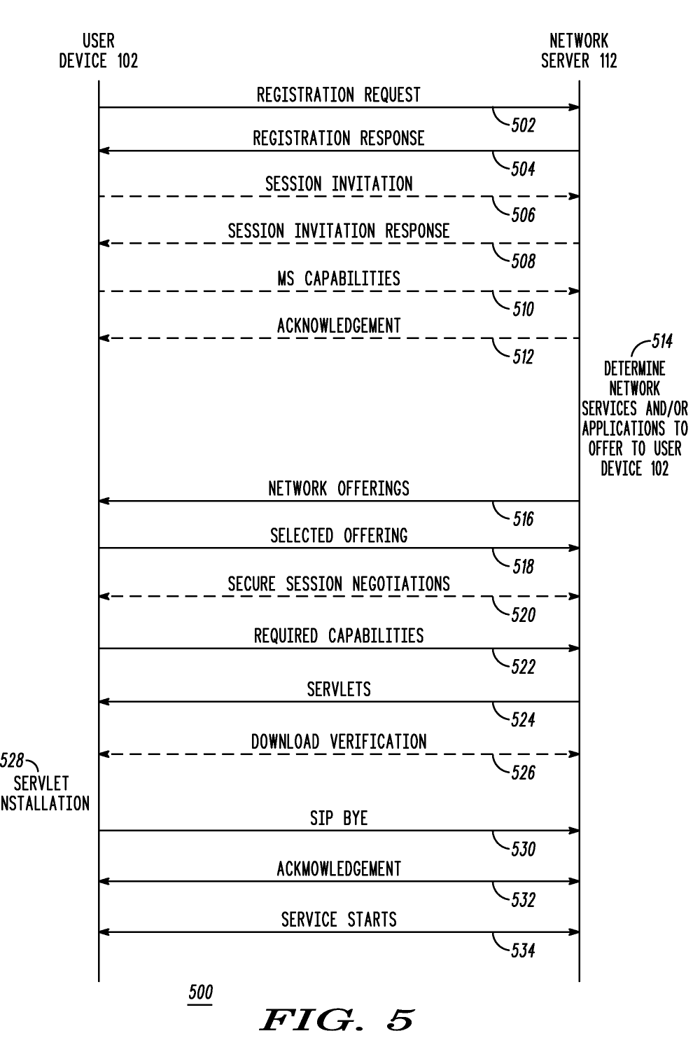

FIG. 5 is an exemplary signal flow diagram 500 illustrating signaling that may be exchanged in a providing of customized network services and/or applications by communication system 100 to a user communication device, such as user device 102, in accordance with various embodiments of the present invention. Signal flow diagram 500 begins when user device 102 initiates a registration with network 120 by conveying 502 a registration request to network server 112. For example, user device 102 may convey a SIP (Session Initiation Protocol) Register message or a UPnP/HTTP: (Universal Plug and Play/Hyper Text Transfer Protocol) message. In response to receiving the registration request, network server 112 acknowledges the registration request and conveys an acceptance of the request by assembling and conveying 504 a registration response, for example, a SIP 200 OK message, to user device 102.

In response to being informed of the acceptance of the registration, user device 102 may initiate a communication session by conveying 506 a session invitation, for example, a SIP Invite, to network server 112 that includes a routing identifier associated with the recipient of the session invitation and information such as a Session Description Protocol (SDP) proposal associated with an establishment of a bearer path via air interface 104 and network 120. As is known in the art, the SDP proposal may include one or more of a type of media, such as video, audio, and so on, a transport protocol, such as RTP/UDP/IP, H.320, and so on, a format of the media, such as H.261 video, MPEG video, codec capabilities, and so on, a remote address for media, and a transport port for contact address. SDP is well-known and is described in detail in 3GPP2 Request for Comments (RFC) 2327. In response to receiving the session invitation, network server 112 may then acknowledge the proposal and convey the acceptance of the proposal or a counter-proposal by assembling and conveying 508 a session invitation response, for example, a SIP 200 OK message, comprising the accepted SDP proposal or the counter-proposal.

Further, in response to being informed of the acceptance of the registration, user device 102 may advertise 510 the capabilities of the user device to network server 112. For example, user device 102 may convey a SIP Notification or a UPnP Discover message whose payload comprises information concerning the capabilities of the user device in an SDP or an XML style sheet. However, in another embodiment of the invention wherein the capabilities of user device 102 are already known to network 120, for example, are included in the user profile associated with the user device and maintained by user database 114, user device 102 may or may not notify the network of its capabilities and/or the SIP Notification or the UPnP Discover message may refer the network, that is, network server 112, to the services and/or applications maintained in the user profile associated with the user device in user database 114. When user device 102 advertises its capabilities to network server 112, the network server may acknowledge 512 the advertisement, for example, by conveying a SIP 200 OK message back to the user device.

Further in response to receiving the registration request from user device 102, network server 112 determines 514 network services and/or applications available for the user device. As described in detail above, network server 112 may determine the available network services and/or applications based on the capabilities of user device 102 received from the user device, by querying user database 114 for a list of services and/or applications subscribed to by the user device, preferred by the user device, and/or supported by the user device, by retrieving information concerning services or applications maintained by the network server in at least one memory device 304 of the server, and/or by querying the at least one AS 116 for a list of network services and/or applications offered by network 120. Network server 112 then compiles the available, that is, the offering, of network services and/or applications and announces, or offers, 516 the available network services and/or applications to user device 102. For example, network server 112 may inform user device 102 of the available network services and/or applications by including the offerings in a payload of a SIP 200 OK message, in an XML sheet included in a SIP Info message or a SIP Notification message, in a UPnP Discover message, or in an HTTP message.

In response to receiving the announcement, that is, the offering, of available services and/or applications, user device 102 displays the offerings to a user of the user device. The user of user device 102 may then select an announced network service or application to produce a selected network service or application and the user device informs 518 network server 112 of the selected network service or application. For example, user device 102 may inform network server 112 of the selected network service or application by including information concerning the selected network service or application in a SIP Notification message or an OMA (Open Mobile Alliance) HTTP message conveyed by the user device to the network server. In addition, network server 112 may negotiate 520 a secure session for a download of the selected service or application.

User device 102 then requests 522 from network server 112 the capabilities required by the user device in order to execute the selected service or application, preferably by conveying an HTTP:GET or an HTTPS:GET message to the network server. In response to receiving the request from user device 102, network server downloads the requested capabilities, for example, an RTSP client, a soft codec, DRM (Digital Rights Management) modules, authorization information, billing information, and so on, from an application layer of the server or from AS 116, and conveys a servlet or servlets to user device 102 comprising the requested capabilities. Network controller 112 may convey the servlet or servlets to user device 102 in the payload of a SIP 200 OK message, in an HTTP:GET or an HTTPS:GET message, or in an OMA/HTTP:GET message. User device 102 and network server 112 may then verify 526 the download and user device 102 installs 528 the received servlet(s) in the at least one memory device 206 of the user device. In response to receiving or installing the servlet(s), user device 102 then terminates 530 the service/application negotiation, for example, by conveying a SIP BYE message to network server 112. Network server 112 acknowledges 532 the SIP BYE message, for example, by conveying a SIP 200 OK message, and the selected service or application is started up 534. Signal flow diagram 500 then ends.

In summarization, communication system 100 ensures that a rich variety and complexity of network offerings may be experienced by users without overloading terminals and clients by offering user-centric network services. When a user device first registers with a network, the user device notifies the network of its client capabilities, such as video, VoIP, presence, and so on. Based on the client capabilities and further based on any user preferences, the network then announces, that is, offers to the user, a list of available services for the user to choose from. With intelligence in the network, network services and applications then may be downloaded and used only when the services and applications are needed or desired by users, thereby allowing a thin middleware layer and network customization. Thus communication system 100 overcomes the encumbrances of the prior art, where network services are generally bundled with a subscription and cannot change dynamically depending on a location (roaming) of a user device and/or user preferences; leading to thick clients that need to support services and applications that may not be needed or desired.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. The terms ‘including’ and/or ‘having’, as used herein, are defined as comprising. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions. An element preceded by “. . . a” does not, without more constraints, preclude the existence of additional identical elements in the process, method, article, or apparatus that the element. The terms program, computer program, computer instructions, and servlet as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for providing network service and application customization comprising:
determining a capability of a user device;
determining one or more network services and applications supported by a network;
determining the requirements of the one or more network services and applications; and
announcing, to the user device, one or more of a network service and an application based on the determined capability of the user device and the requirements of the one or more network services and applications supported by the network.

2. The method of claim 1, wherein determining a capability of a user device comprises one or more of:
receiving, from the user device, information concerning a capability of the user device; and
querying a user database for information concerning a capability of the user device.

3. The method of claim 1, wherein determining one or more network services and applications supported by a network comprises determining one or more network services and applications supported by an application server.

4. The method of claim 1, further comprising receiving, from the user device, a selection of an announced network service or application.

5. The method of claim 4, further comprising conveying, to the user device, software to support the selected network service or application.

6. The method of claim 5, further comprising:
receiving, by the user device, the software to support the selected network service or application; and
installing, by the user device, the received software.

7. The method of claim 4, wherein receiving a selection of a network service or application comprises:
displaying, by the user device, the offered one or more of a network service and an application;
receiving, from a user of the user device, a selection of a network service or application of the announced one or more of a network service and an application to produce a selected service or application; and
informing, by the user device, of the selected service or application.

8. A method for providing network service and application customization comprising:
determining one or more network services and applications that are one or more of supported by a user device and preferred by the user device;
determining one or more network services and applications supported by a network; and
announcing, to the user device, one or more network services and applications that are one or more of supported by the user device and preferred by the user device and further that are supported by the network.

9. The method of claim 8, wherein determining one or more network services and applications that are one or more of supported by a user device and preferred by the user device comprises one or more of:
receiving, from the user device, information concerning one or more network services and applications that are one or more of supported by the user device and preferred by the user device; and
querying a user database for information concerning one or more network services and applications that are one or more of supported by the user device and preferred by the user device.

10. The method of claim 8, further comprising receiving, from the user device, a selection of an announced network service or application.

11. The method of claim 10, further comprising conveying, to the user device, software to support the selected network service or application.

12. The method of claim 11, further comprising:
receiving, by the user device, the software to support the selected network service or application; and
installing, by the user device, the received software.

13. The method of claim 10, wherein receiving a selection of a network service or application comprises:
displaying, by the user device, the offered one or more of a network service and an application;
receiving, from a user of the user device, a selection of a network service or application of the announced one or more of a network service and an application to produce a selected service or application; and
informing, by the user device, of the selected service or application.

14. A network server that provides a customized offering of one or more of a network service and an application to a user device, wherein the network server is configured to determine a capability of the user device, determine one or more network services and applications supported by a network, determine the requirements of the one or more network services and applications, and announce one or more of a network service and an application to the user device based on the capabilities of the user device and the requirements of the one or more network services and applications supported by the network.

15. The network server of claim 14, wherein the network server is configured to determine a capability of a user device based one or more of information received from the user device and information obtained by querying a user database for information concerning a capability of the user device.

16. The network server of claim 14, wherein the network server further is configured to receive a selection of an announced network service or application from the user device.

17. The network server of claim 15, wherein the network server further is configured to convey, to the user device, software to support the selected network service or application.

18. The network server of claim 17, wherein the network server is configured to convey software to support the selected network service or application by conveying one or more servlets to the user device.

19. A network server that provides a customized offering of one or more of a network service and an application to a user device, wherein the network server is configured to determine one or more network services and applications that are one or more of supported by the user device and preferred by the user device, determine one or more network services and applications supported by a network, and announce one or more of a network service and an application to the user device based on the one or more network services and applications that are one or more of supported by and preferred by a user device and the one or more network services and applications supported by a network.

20. The network server of claim 19, wherein the network server is configured to determine one or more network services and applications that are one or more of supported by the user device and preferred by the user device by one or more of:
receiving, from the user device, information concerning one or more network services and applications that are one or more of supported by the user device and preferred by the user device; and
querying a user database for information concerning one or more network services and applications that are one or more of supported by the user device and preferred by the user device.

21. The network server of claim 19, wherein the network server further is configured to receive, from the user device, a selection of an announced network service or application.

22. The network server of claim 21, wherein the network server further is configured to convey, to the user device, software to support the selected network service or application.

23. The network server of claim 22, wherein the network server is configured to convey software to support the selected network service or application by conveying one or more servlets to the user device.
